(19) United States
(12) Patent Application Publication
(10) Pub. No.: US 2012/0192726 A1
(43) Pub. Date: Aug. 2, 2012

(54) CONVECTION GRILL

(76) Inventors: Christopher Clearman, Anderson, SC (US); Ryan T. Harrison, Anderson, SC (US); Robert E. McCracken, Anderson, SC (US); Mark Huggins, Anderson, SC (US); Scott Kippes, Anderson, SC (US); Adam Clark, Anderson, SC (US)

(21) Appl. No.: 13/363,791

(22) Filed: Feb. 1, 2012

Related U.S. Application Data
(60) Provisional application No. 61/438,399, filed on Feb. 1, 2011.

(51) Int. Cl. A47J 37/07

(52) U.S. Cl. 99/447

(57) ABSTRACT

A convection grill including a body having a base and a lid, and defining a cooking chamber, and a convection system coupled to a wall of the base. The convection system includes an air conduit defined at least in part by a front panel and a back panel, the air conduit including an intake aperture, a duct, and an exhaust vent. The convection system also includes a fan assembly including a convection fan positioned within the duct proximate to the intake aperture, and a motor coupled to the convection fan by a motor shaft. The back panel includes a first end distal from the wall, a second end proximate the wall, and a cross section having a substantially continuous curve between the first and second ends.

### RELATED APPLICATIONS

This application claims priority to U.S. Provisional Patent Application Ser. No. 61/438,399 filed on Feb. 1, 2011, the entire contents of which are hereby incorporated by reference.

### FIELD

The present disclosure generally relates to outdoor cooking devices and, more particularly, to grills.

### BACKGROUND

Barbeque grills, such as charcoal and gas grills, are very popular means of cooking foods and may often be used as alternatives to conventional stoves. Such grills generally include a body having a base and a lid and defining a cooking chamber, a cooking grill supported in an upper portion of the base, and a heat source positioned in a lower portion of the base below the grill. The heat source may include solid fuel, such as charcoal, positioned on a grate, or other fuel, such as propane, supplied through a gas burner.

Heat produced by the heat source of the grill is generally not evenly distributed throughout the cooking chamber. Heat in the central portion of the cooking chamber is often more intense than at the side portions. This may cause uneven cooking of foods at various locations on the cooking grill.

The present invention may generally provide a barbeque grill having a convection system that evenly distributes heat throughout the cooking chamber. The convection system is easy to manufacture and clean and is configured to impede the build-up of grease that enters the system.

### SUMMARY

In one independent aspect, a convection grill may generally include a body having a base and a lid, and defining a cooking chamber, and a convection system coupled to a wall of the base. The convection system may include an air conduit defined at least in part by a front panel and a back panel, the air conduit including an intake aperture, a duct, and an exhaust vent. The convection system may also include a fan assembly including a convection fan positioned within the duct proximate to the intake aperture, and a motor coupled to the convection fan by a motor shaft. The back panel may have a first end distal from the wall, a second end proximate the wall, and a cross section having a substantially continuous curve between the first and second ends.

In another independent aspect, a convection grill may generally include a body having a base and a lid, and defining a cooking chamber, and a convection system coupled to a wall of the base. The convection system may include an air conduit defined at least in part by a front panel and a back panel, the air conduit including an intake aperture, a duct, and an exhaust vent. The convection system may also include a fan assembly including a convection fan positioned within the duct proximate to the intake aperture, and a motor coupled to the convection fan by a motor shaft. The exhaust vent may have a substantially elliptical shape.

In yet another independent aspect, a convection grill may generally include a body having a base, a lid, and defining a cooking chamber, and a convection system coupled to a wall of the base. The convection system may include an air conduit defined at least in part by a front panel and a back panel, the air conduit including an intake aperture, a duct, and an exhaust vent. The convection system may also include a fan assembly including a convection fan positioned within the duct proximate to the intake aperture, and a motor coupled to the convection fan by a motor shaft. The back panel may have a curvature adapted to cause liquids entering into the air conduit from the cooking chamber to drain back into the cooking chamber via the exhaust vent.

Other independent aspects of the barbeque grills of this disclosure will become apparent by consideration of the detailed description, claims and accompanying drawings.

### BRIEF DESCRIPTION OF THE DRAWINGS

FIG. 1 is a front perspective view of a barbeque grill with a convection system in accordance with a first embodiment of the invention.

FIG. 2 is a rear perspective view of the grill of FIG. 1.

FIG. 3 is a cross-sectional top view of the grill of FIG. 1.

FIG. 4 is a cross-sectional side view of the grill of FIG. 1.

FIG. 5 is an enlarged view of a portion of a barbeque grill with a convection system in accordance with a second embodiment of the invention.

FIG. 6 is an enlarged view of a portion of a barbeque grill with a convection system in accordance with a third embodiment of the invention.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Ordinal indicators, such as first, second, and third, as used in the description and the claims to refer to various structures, are not meant to be construed to indicate any specific structures, or any particular order or configuration to such structures. All methods described herein can be performed in any suitable order unless otherwise indicated herein or otherwise clearly contradicted by context. The use of any and all examples, or exemplary language (e.g., “such as”) provided herein, is intended merely to better illuminate aspects of the invention and does not pose a limitation on the scope of the invention unless otherwise claimed. No language in the specification, and no structures shown in the drawings, should be construed as indicating that any non-claimed element is essential to the practice of the invention.

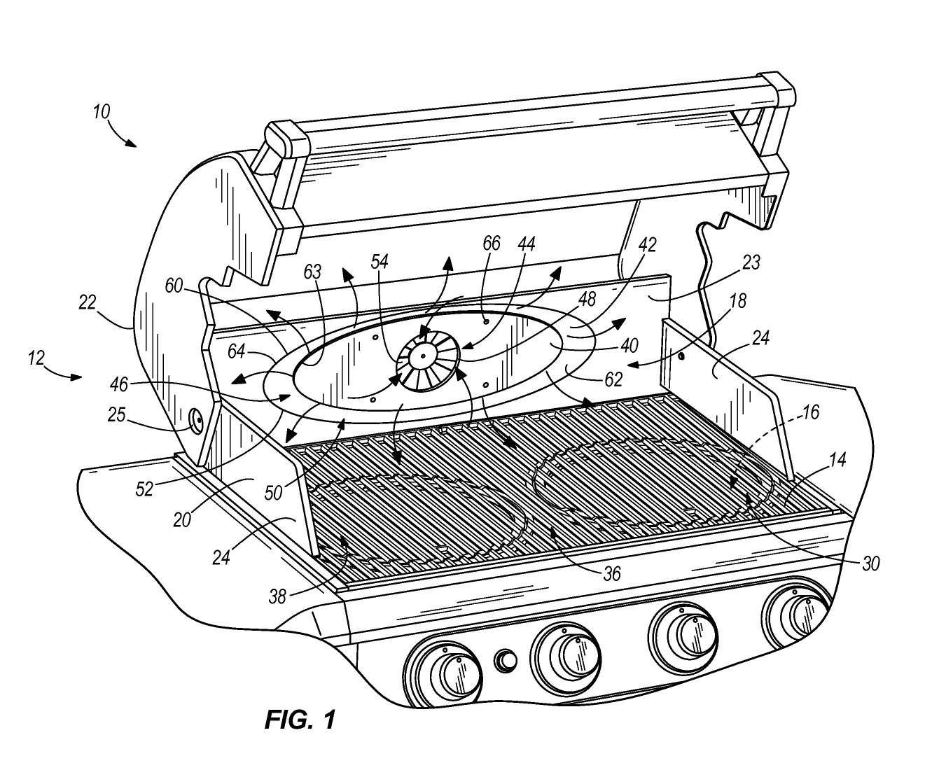

FIGS. 1-4 illustrate an exemplary barbeque grill 10 according to independent aspects of the present invention. The illustrated grill 10 is a moveable outdoor gas grill. It should be understood that aspects of the invention are applicable to other types of cooking devices, such as indoor grills, built-in grills, charcoal grills, smokers, etc.

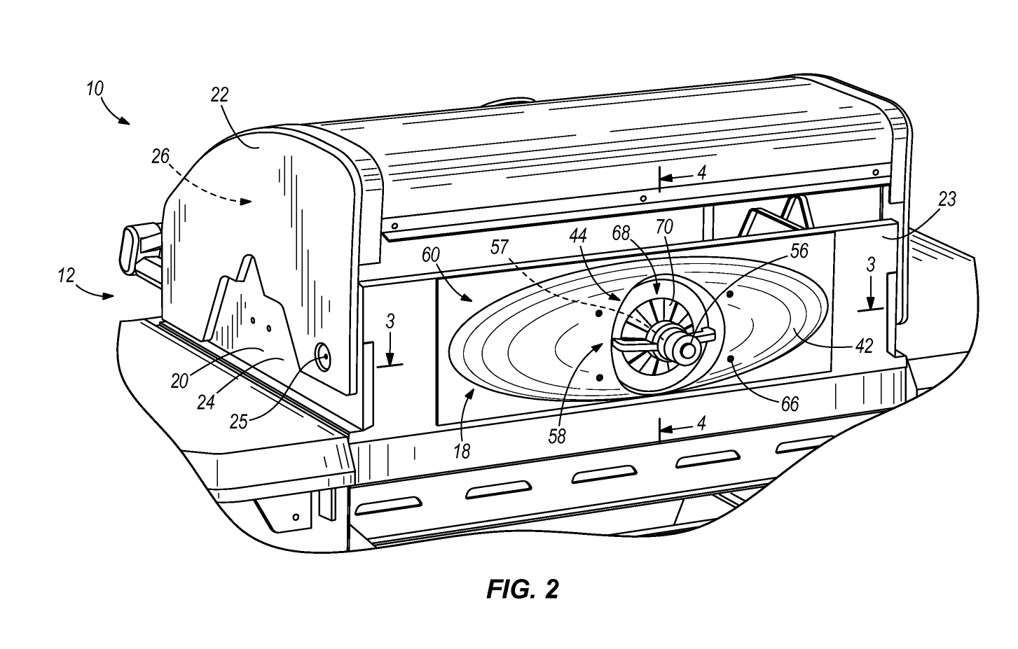

The grill 10 includes a body 12, a cooking grill 14, a heat source 16, and a convection system 18. The body 12 may include a base 20 and a lid 22. The base 20 may include a plurality of walls, including a back wall 23 and side walls 24. The lid 22 is pivotally attached to the base 20 by a hinge 25 and is pivotable between an open position (shown in FIG. 1) and a closed position (shown in FIG. 2). When the lid 22 is in the closed position, the body 12 defines a cooking chamber 26 generally including a central portion 28, side portions 30, a top portion 32 and a bottom portion 34. Various components of the body 12 may have any desired size and shape and are constructed of any suitable materials.

The cooking grill 14 is supported by the base 20 and includes a middle portion 36, generally positioned in the central portion 28 of the cooking chamber 26, and opposed end portions 38, generally positioned in the side portions 30 of the cooking chamber 26. The cooking grill 14 may have any desired size and shape and is constructed of any suitable materials.

The heat source 16 is supported by the base 20 beneath the cooking grill 14, generally in the bottom portion 34 of the cooking chamber 26. In the illustrated embodiment, the heat source 16 includes a gas burner. The grill 10 may include one or more secondary heating elements including, but not limited to, lava rocks, ceramic briquettes, steel bars, etc., which absorb heat from the gas burner, and then radiate that heat throughout the cooking chamber 26 in a more even manner than could be attained with the gas burner alone. In other embodiments, the heat source 16 may be charcoal or another fuel.

The convection system 18 is positioned proximate the cooking chamber 26 and draws air from the central portion 28 of the cooking chamber 26 and redistributes the drawn air to one or more of the opposed side portions 30, top portion 32 and bottom portion 34 of the cooking chamber 26. The convection system 18 is attached or otherwise coupled to the back wall 23 of the base 20 and includes a front panel 40, a back panel 42, and a fan assembly 44. The various components of the convection system may have any desired size and shape and are constructed of any suitable materials.

The front panel 40 and the back panel 42 together define an air conduit 46 between the central portion 28 of the cooking chamber 26 and one or more of the opposed side portions 30, the top portion 32, and the bottom portion 34 of the cooking chamber 26. The air conduit 46 defined by the front and back panels 40, 42 includes an intake 48, a duct 50, and an exhaust vent 52. The front panel 40 is substantially parallel to or co-planar with at least a portion of the back wall 23 and may include an aperture that defines the intake 48. As discussed in more detail below, the back panel 42 may extend substantially transversely outwardly away from the back wall 23 of the base 20 and/or away from the front panel 40, and may be spaced from the front panel 40 in a manner that defines the duct 50 and the exhaust vent 52.

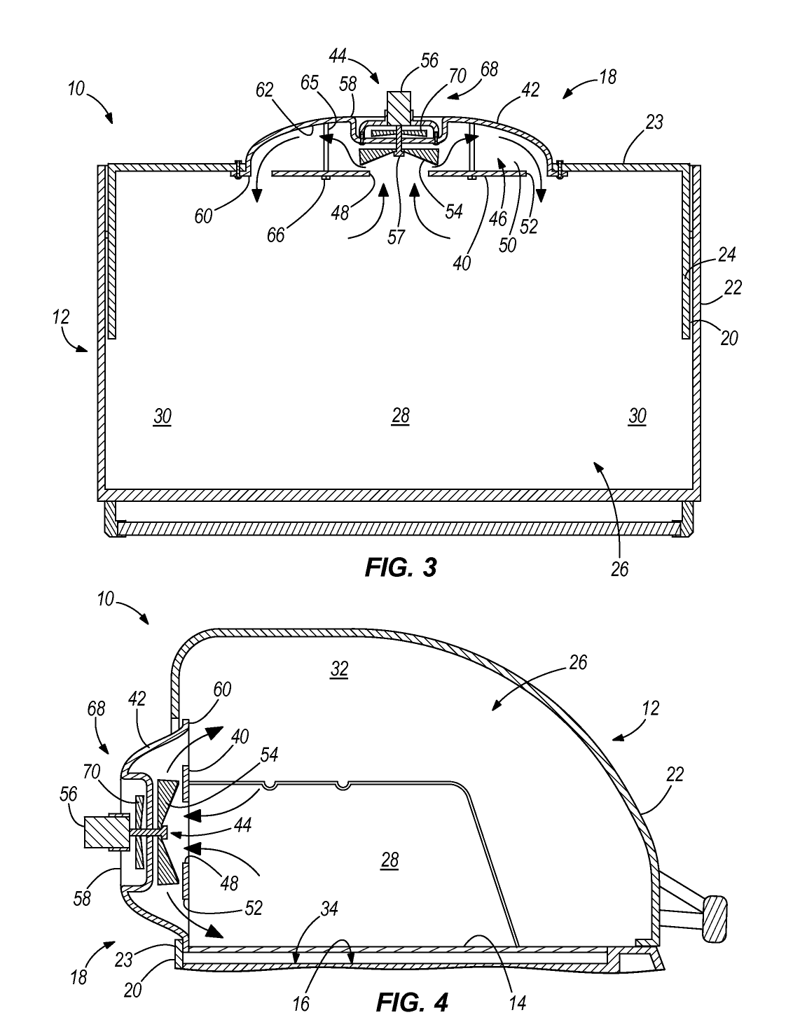

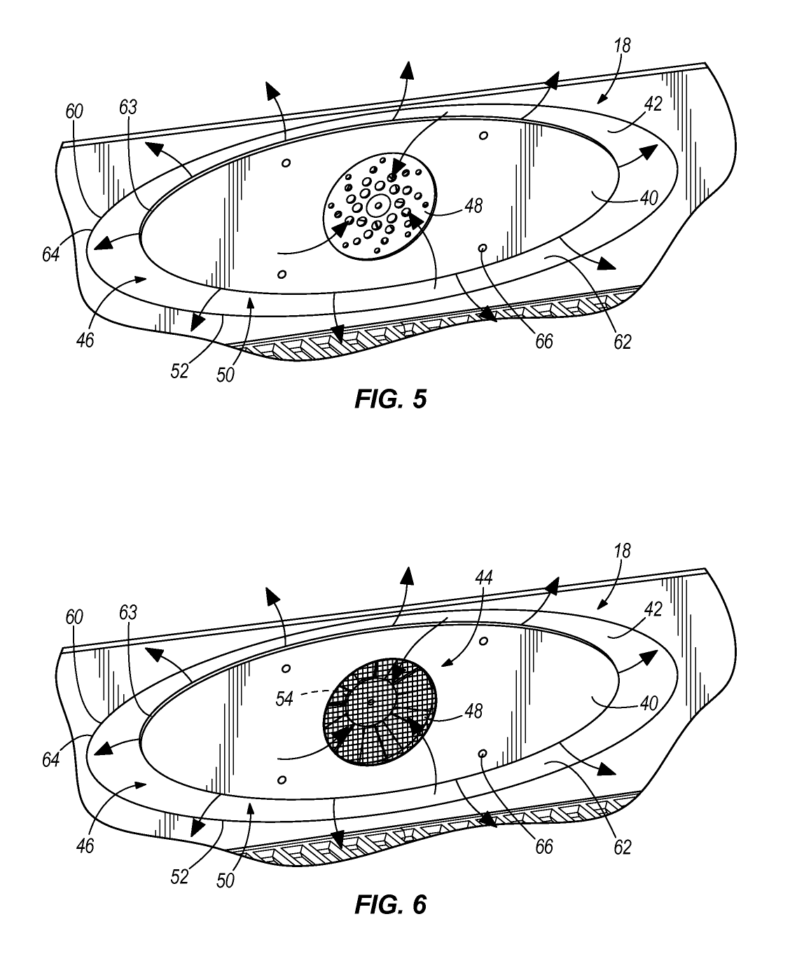

The fan assembly 44 includes a fan 54 and a motor 56 coupled to the fan 54 with a motor shaft 57 for driving the fan 54. The fan 54 is positioned within the duct 50 proximate the intake 48. As best shown in FIGS. 3-4, the fan 54 is configured to draw air from the central portion 28 of the cooking chamber 26, through the intake 48 and into the duct 50, and then out of the duct 50 through the exhaust vent 52 into one or more of the opposed side portions 30, the top portion 32 and/or the bottom portion 34 of the cooking chamber 26. In some embodiments, the intake 48 may be at least partially covered with a metal mesh screen or filter (as shown in FIGS. 5-6) to inhibit grease, particulate matter, fingers, tools, etc., from reaching the fan 54. The intake 48 may have a spiral arrangement of inlet openings (FIG. 5) or a grid-like pattern of inlet openings (FIG. 6). In the illustrated spiral arrangement of inlet openings (FIG. 5), the openings are substantially shaped as circles having different diameters. In other constructions (not shown), the openings may have different shape(s) and/or size(s).

The front panel 40 and/or back panel 42 may be shaped to substantially evenly distribute air about the cooking chamber 26 without directional fairings to guide air movement and/or to cause grease, juices or other liquids entering the air conduit 46 to drain back into the cooking chamber 26. For example, as best shown in FIGS. 3-4, the back panel 42 may include a first end 58 distal from the back wall 23 and a second end 60 proximate the back wall 23.

One or more cross sections of the back panel 42 may have a substantially continuous curve between the first and second ends 58, 60. For example, one or more cross sections of the back panel 42 may have a substantially continuous parabolic shape. This substantially continuous curve between the first and second ends 58, 60 may cause, or urge, grease or other liquids entering the air conduit 46 to drain down the inner surface 62 of the back panel 42 and out the exhaust vent 52 back into the cooking chamber. The shape of the back panel 42 may thus reduce the amount of cleaning and other maintenance required to keep the convection system 18 operating properly.

As best shown in FIGS. 1 and 3-4, the substantially continuous curve of the back panel 42 also may effectively cause air entering the air conduit to be substantially evenly distributed through the exhaust vent 52 to the side portions 30, top portion 32 and/or bottom portion 34 of the cooking chamber 26 without the need for directional fairings to guide air movement. In some embodiments, the shape of the front and back panels 40, 42 may define an exhaust vent 52 having a substantially elliptical shape. For example, the front panel 40 may define a first vent edge 63 having a substantially elliptical shape, and the second end 60 of the back panel 42 may define a second vent edge 64 having a substantially elliptical shape that is larger than the shape of the front panel 40. The substantially elliptical shape of the resulting exhaust vent 52 may cause air exhausted through the vent 52 to be more evenly distributed to the side portions 30, top portion 32 and/or bottom portion 34. In other words, the elliptical shape of the exhaust vent 52 either alone or in combination with the curvature of the back panel 42 may cause air exhausted through the exhaust vent 52 to be more evenly distributed to the cooking chamber 26 than would otherwise be allowed by an exhaust vent having a rectangular shape. The rectangular shape has discrete corners or turns that could block air movement or at least cause exhausted air to move unevenly into the cooking chamber and thus create uneven heat intensity and cooking of foods in the cooking chamber. The elliptical shape, however, provides a continuous curved shape that guides air movement without having discrete corners or turns than could alter the distribution of air to the cooking chamber 26.

The front panel 40 may be coupled to the back panel 42 in a manner that allows it to be quickly and easily disengaged from the back panel 42 to provide access to the fan 54 and the inner surfaces of the air conduit 46. For example, the front and back panels 40, 42 may be spaced from one another with spacers 65 and coupled together with bolts, screws or other suitable fasteners 66. These fasteners 66 may be easily disengaged, such as with a wrench, socket wrench, screwdriver, other tool, etc., to remove the front panel 40 for accessing the fan 54 and inner surfaces of the air conduit 46, such as for cleaning.

The fan assembly 44 may include a heat management system 68 adapted to reduce the temperature of the motor 56 and/or shield the motor 56 from heat. The heat management system 68 includes a cooling fan 70 coupled to the motor shaft 57 between the base 20 (e.g., the hot cooking chamber 26) and the motor 56 to blow air across the motor 56 during operation of the motor 56. The external fan 70 can be used to shield the motor 56 from heat when the motor 56 is not running and as a cooling fan when the motor 56 is running More heat is transferred to the motor 56 when the motor 56 is running because hot air is being drawn over the back plate 42, fan 54, and fan/motor shaft 57. The fan 70 helps dissipate the additional heat.

In some embodiments, the cooling fan 70 functions as a heat shield due to the position, shape and/or material of the fan. For example, the fan 70 may include a central member 72 having a width (e.g., diameter) that is equal to or greater than the width of the motor 56 and positioned between the body 12 and the motor 56. The central member 72 and/or the blades of the fan 70 may be formed of (e.g., composed of or coated with) one or more heat resistant materials including, but not limited to, stainless steels, titanium or titanium alloys, nickel-chromium alloys, ceramic materials, carbon alloys, carbon-carbon composites, fiberglass materials, phenolic resins, etc. In some embodiments, the heat management system 68 may not include a fan 70 at all but instead may only include a heat shield.

Thus, the present invention may generally provide, among other things, barbeque grills with a convection system. The convection system 18 may eliminate or reduce grease build-up since the grease can run out the bottom of the parabolic ducting. The convection system 18 may be relatively easy to manufacture, replacing any complex ducting with a single stamping and face plate 40. Removing the front plate 40 may provide easy access to all duct work and the fan 54 for cleaning.

What is claimed is:

1. A convection grill comprising:
a body including a base and a lid and defining a cooking chamber; and
a convection system coupled to a wall of the base, the convection system including
an air conduit defined at least in part by a front panel and a back panel, the air conduit including an intake aperture, a duct, and an exhaust vent, the back panel having a first end distal from the wall, a second end proximate the wall, and a cross section with a substantially continuous curve between the first end and the second end, and
a fan assembly including a convection fan positioned within the duct proximate to the intake aperture, and a motor coupled to the convection fan by a motor shaft.

2. The convection grill of claim 1, wherein the cross section has a substantially continuous parabolic shape.

3. The convection grill of claim 1, wherein the substantially continuous curve is constructed to cause liquids that enter into the air conduit from the cooking chamber to drain back into the cooking chamber via the exhaust vent.

4. The convection grill of claim 1, wherein the exhaust vent has a substantially elliptical shape.

5. The convection grill of claim 4, wherein the shape of the exhaust vent causes air entering the air conduit through the intake aperture to be substantially evenly distributed into the cooking chamber via the exhaust vent.

6. The convection grill of claim 1, wherein the front panel defines a first vent edge having a substantially elliptical shape, and wherein the second end of the back panel defines a second vent edge having a substantially elliptical shape that is larger than the shape of the front panel.

7. The convection grill of claim 1, wherein the front panel is substantially co-planar with at least a portion of the wall.

8. The convection grill of claim 1, wherein the back panel extends substantially transversely outwardly from the wall.

9. The convection grill of claim 1, wherein the intake aperture is covered by a filter.

10. A convection grill comprising:
a body including a base and a lid and defining a cooking chamber; and
a convection system coupled to the body, the convection system including
an air conduit defined at least in part by a front panel and a back panel, the air conduit including an intake aperture, a duct, and an exhaust vent, the exhaust vent having a substantially elliptical shape, and
a fan assembly including a convection fan positioned within the duct proximate to the intake aperture, and a motor coupled to the convection fan by a motor shaft.

11. The convection grill of claim 10, wherein the shape of the exhaust vent causes air entering the air conduit through the intake aperture to be substantially evenly distributed into the cooking chamber via the exhaust vent.

12. The convection grill of claim 10, wherein the front panel defines a first vent edge having a substantially elliptical shape, and wherein the back panel defines a second vent edge having a substantially elliptical shape that is larger than the shape of the front panel.

13. The convection grill of claim 10, wherein the convection system is coupled to a wall of the base, and wherein the front panel is substantially co-planar with at least a portion of the wall.

14. The convection grill of claim 10, wherein the convection system is coupled to a wall of the base, and wherein the back panel extends transversely outwardly from the wall.

15. The convection grill of claim 10, wherein the intake aperture is at least partially covered by a filter.

16. A convection grill comprising:
a body including a base, a lid, and defining a cooking chamber; and
a convection system coupled to the body, the convection system including
an air conduit defined at least in part by a front panel and a back panel, the air conduit including an intake aperture, a duct, and an exhaust vent, the back panel having a curvature to cause liquids entering into the air conduit from the cooking chamber to drain back into the cooking chamber via the exhaust vent, and
a fan assembly including a convection fan positioned within the duct proximate to the intake aperture, and a motor coupled to the convection fan by a motor shaft;

17. The convection grill of claim 16, wherein the shape of the exhaust vent causes air entering the air conduit through the intake aperture to be substantially evenly distributed into the cooking chamber via the exhaust vent.

18. The convection grill of claim 16, wherein the front panel defines a first vent edge having a substantially elliptical shape, and wherein the back panel defines a second vent edge having a substantially elliptical shape that is larger than the shape of the front panel.

19. The convection grill of claim 16, wherein the convection system is coupled to a wall of the base, wherein the front panel is substantially co-planar with at least a portion of the wall, and wherein the back panel extends transversely outwardly from the wall.

20. The convection grill of claim 16, wherein the intake aperture is at least partially covered by a filter.
